(19) United States
(12) Patent Application Publication
(10) Pub. No.: US 2007/0079491 A1
(43) Pub. Date: Apr. 12, 2007

(54) Method and apparatus for detecting rivets

(75) Inventor: Max Hader, Affing (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottobrunn (DE)

(21) Appl. No.: 11/543,937

(22) Filed: Oct. 6, 2006

(30) Foreign Application Priority Data
Oct. 8, 2005 (DE) 102005048325.9-14

(51) Int. Cl. B23Q 17/00

(52) U.S. Cl. 29/407.1; 29/524.1; 29/525.06; 29/715

(57) ABSTRACT

In a method for detecting presence of rivets in riveting machines, an allowed rivet is detected by comparing the light reflected from it with a predetermined limit value.

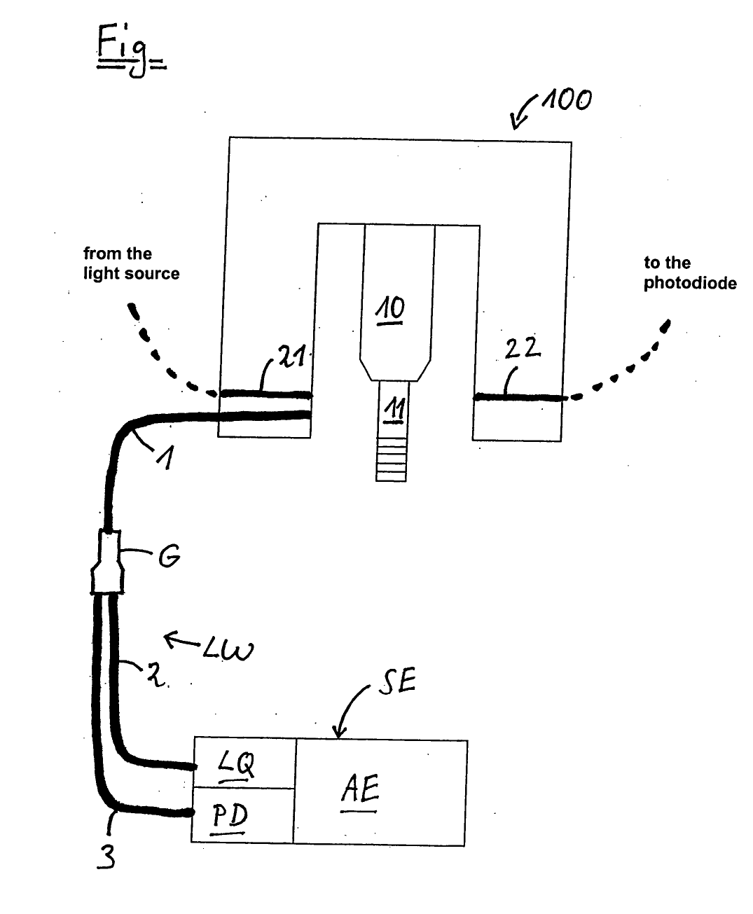

### BACKGROUND AND SUMMARY OF THE INVENTION

This application claims the priority of German patent document 10 2005 048 325.9, filed Oct. 8, 2005, the disclosure of which is expressly incorporated by reference herein.

The invention relates to a method for detecting rivets, and to a device for performing the method, including in particular for aviation.

In aviation, different fasteners, which differ in materials and in handling, are used for joining structural elements in general. Since individual ones of these fasteners are very similar in size and shape, the possibility cannot be ruled out that a non-loosening screw connection (High-Lock®) made of titanium might be used in a riveting machine for processing aluminum rivets. If not detected, it will be compressed at a high pressure, which can result in major damage to the component being joined.

One object of the present invention, therefore, is to provide a method and apparatus by which a rivet that is provided for processing in a riveting machine can be detected reliably, so that the riveting cycle can be interrupted if necessary.

This and other objects and advantages are achieved by the detection method and apparatus according to the invention, in which a suitable rivet is recognized on the basis of its light reflection characteristics. For example, aluminum rivets are coated with an anodizing layer as surface protection. Therefore, they appear with a light/glossy yellowish color. On the other hand, non-loosening screw connections (High-Locks®), which are not suitable for use as rivets, appear dark with a bluish hue. If the rivet finger of the riveting machine holds such a fastener that is not suitable for riveting, this incorrect fastener will be detected, because of its lower reflectivity in comparison with that of a bright aluminum rivet. The quantity of light received is then below a predetermined limit, which is set according to the reflective properties of the relevant rivets and/or fasteners.

If an unsuitable or improper fastener is detected in the rivet finger, an error signal is generated and displayed on the monitor for the operator of the riveting machine, for example. At the same time, the riveting cycle is stopped automatically due to the error signal.

Rivet detection may also be combined with load status detection of the rivet finger. That is, a check is performed to ascertain whether a fastener is present in the rivet finger. To do so, a commercial transmitted-light barrier is used, where the light transmitter and the photodiode are situated on a line. A fastener present in the finger interrupts the beam of light. Rivet detection according to the invention is performed only when load state detection reports the “fastener present” state.

However, the method according to the invention may also be used for detection of rivets that have lost their surface protection and therefore should no longer be processed. In comparison with rivets having intact surface protection, such rivets also have a reduced reflectivity, by which they can be recognized.

In the examples explained so far, suitable rivets have a higher reflectivity in comparison with other (unsuitable) fasteners, so the reflected light value is higher than the preset limit value. There are naturally conceivable situations in Which the allowed rivets have a lower reflectivity in comparison with the disallowed fasteners that must be taken into account. Even in this case, reliable detection is of course possible by means of this invention.

With the method according to the invention, the components to be joined may be protected from damage, so that rejects, design deviations and repairs are avoided.

Other objects, advantages and novel features of the present invention will become apparent from the following detailed description of the invention when considered in conjunction with the accompanying drawings.

### BRIEF DESCRIPTION OF THE DRAWINGS

The single FIGURE shows schematically the rivet head of a riveting machine for aviation use; on which there is a device for performing the inventive method.

### DETAILED DESCRIPTION OF THE INVENTION

Referring to the drawings, a cylindrical, movable rivet finger 10 on the rivet head 100 holds a rivet 11 to be tested. The end of an optical fiber LW is secured opposite it, and at the same level. The other end of this optical fiber LW is connected to a sensor device SE, comprising a light source LQ, a photodetector PD and an analyzer unit AE. The optical fiber LW advantageously has a fork G at which the optical fiber 1 on the rivet end branches into two optical fibers 2, 3. Light emanating from the light source LQ is output completely into the optical fiber 1 on the rivet head end, while the light from the optical fiber 1 on the rivet head end to the fork piece is input into the optical fiber 3, which is connected to the photodiode PD.

After passing through the optical fibers 2 and 1, the radiation emanating from the light source LQ strikes the test body 11 and is reflected by it. The reflected light is sent over the optical fibers 1 and 3 to the photodiode PD. In the analyzer unit AE in the sensor SE, the reflected energy is compared with a preset limit (which may be adjusted freely and continuously) to differentiate an allowed rivet from another type of fastener that is not allowed. The output signal of the sensor device is relayed to the control unit of the riveting machine to interrupt the riveting cycle upon detection of a disallowed fastener. The operator of the riveting machine receives a corresponding instruction on his monitor and removes the disallowed fastener.

Rivet detection may also be combined with load state recognition of the rivet finger. A continuous light barrier is used to ascertain whether a fastener is in the rivet finger 10. One end of the optical fiber 21 connected to the light source of the light barrier and one end of the optical fiber 22 connected to the photodiode of the light barrier lie on a line, so that the beam of light is interrupted when fastening means 11 are present there. The light barrier is coupled to the sensor device SE so that the inventive rivet detection is performed only when the load state recognition reports the state “fastening means present.”

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for detecting presence of a rivet in a riveting machine, comprising:
measuring light reflected from an object in said riveting machine; and
detecting that said object is an allowed rivet which can be used in said riveting machine by comparing light reflected from said object with a predetermined limit value.

2. The method for rivet detection as claimed in claim 1, further comprising:
generating an error signal upon detecting presence of a fastener other than an allowed rivet.

3. The method for rivet detection as claimed in claim 2, further comprising:
upon detection of an object other than an allowed rivet, stopping a riveting cycle of the riveting machine.

4. The method for rivet detection as claimed in claim 1, further comprising:
differentiating the states “fastening means present” and “fastening means not present”; and
performing the check for allowed rivets only when the state “fastening means present” is detected.

5. The method as claimed in claim 1, wherein said reflected light is measured to detect a surface state of a rivet.

6. A device for detecting presence of a rivet in a riveting machine, said device comprising:
a light source for emitting light onto an object situated in a rivet finger of the riveting machine;
a photodetector for receiving light reflected by the object; and
an analyzer unit for comparing a quantity of light received in the photodetector with a predetermined limit value suitable for differentiating a rivet from other objects and for generating an error signal if an object other than a rivet is detected.

7. The device as claimed in claim 6, wherein the light is guided to and from the object via optical fibers.

8. The device according to claim 7, wherein a forked optical fiber is used.

9. The device according to claim 8, wherein a through-light barrier is provided for detecting whether an object is present in the rivet finger.

10. For use in a riveting machine, a method of determining that an object present in the machine is an allowed rivet which can be used in the riveting machine, said method comprising:
directing a beam of light onto the object;
measuring light reflected by the object;
comparing a measured value of said reflected light with a predetermined limit value; and
determining whether said object is an allowed rivet based on a result of said comparing.

11. The method according to claim 10, further comprising:
differentiating the states “fastening means present” and “fastening means not present”; and
performing the check for allowed rivets only when the state “fastening means present” is detected.

12. The method as claimed in claim 10, wherein said reflected light is measured to detect a surface state of a rivet.
